(19) United States
(12) Patent Application Publication
(10) Pub. No.: US 2006/0144605 A1
(43) Pub. Date: Jul. 6, 2006

(54) Shock-absorbing structure for pneumatic tool

(76) Inventor: Hsiu-Ju Chen, Taichung (TW)

Correspondence Address: CHARLES E. BAXLEY, ESQ., 90 JOHN STREET, THIRD FLOOR, NEW YORK, NY, 10038, US

(21) Appl. No.: 11/365,713

(22) Filed: Mar. 1, 2006

Related U.S. Application Data
(63) Continuation-in-part of application No. 10/701,531, filed on Nov. 6, 2003, now abandoned.

(51) Int. Cl. B25D 11/00

(52) U.S. Cl. 173/211; 173/162.1

(57) ABSTRACT

A shock-absorbing structure installed in a pneumatic tool to absorb shocks from the impact unit of the pneumatic tool is disclosed to include a housing, and a shock-absorbing socket, the shock-absorbing socket having a socket body fastened to the impact unit and axially movably mounted in a receiving hole inside the housing, a first spring coil connected between the rear side of the socket body and the housing and alternatively compressed and stretched to absorb shocks upon reciprocating motion of the impact unit, and a second spring coil connected between the front side of the socket body and the housing and alternatively compressed and stretched in direction reversed to the first spring coil upon reciprocating motion of the impact unit.

This application is a continuation of part of U.S. patent application Ser. No. 10/701,531 filed on Nov. 6, 2003, which claims the benefit of the earlier filing date.

### BACKGROUND OF THE INVENTION

1. Field of the Invention

The present invention relates to a pneumatic tools and, more specifically, to a shock-absorbing structure for use in a pneumatic tool to absorb shocks from the impact unit.

2. Description of the Prior Art

During the use of a pneumatic tool, more particularly a reciprocating type pneumatic tool, the action of the impact unit causes a heavy vibration. If the pneumatic tool has no means to absorb shocks, shocks will be directly transmitted from the impact unit to the user's hands, thereby causing an injury.

Therefore, various shock-absorbing designs and products are developed. However, these designs commonly use coil spring members or the like to absorb shocks. However, these conventional designs do not achieve a significant shock-absorbing effect. Further, it is difficult to control the coefficient of elasticity. Due to high-frequency vibrations, the parts of the shock-absorbing structure wear quickly with use and must be frequently replaced.

U.S. Pat. No. 2,875,731 discloses a shock absorber that essentially comprises a socket, two end caps, two springs and a mass. The end caps are screwed to both ends of the socket, each of the two springs is biased between the mass and an end of the end caps. The disadvantages of this shock absorber is that the end caps screwed at both ends of the socket are likely to be loosened, and the structure of the shock absorber is two complicated and difficult to assemble. If the components of the shock absorber are integral with each other, namely, if the shock absorber is a unitary structure, this problem will be solved.

### SUMMARY OF THE INVENTION

The present invention has been accomplished under the circumstances in view. It is one object of the present invention to provide a shock-absorbing structure for pneumatic tool, which effectively reduces impact shocks of the pneumatic tool.

It is another object of the present invention to provide a shock-absorbing structure for pneumatic tool, which is detachable for convenient assembly.

It is still another object of the present invention to provide a shock-absorbing structure for pneumatic tool, which is durable in use.

To achieve these and other objects of the present invention, the shock-absorbing structure is installed in a pneumatic tool to absorb impact shocks from the impact unit of the pneumatic tool. The shock-absorbing structure comprises a housing, and a shock-absorbing socket. The housing comprises a mounting body, a first fitting hole and a second fitting hole formed in the mounting body, a receiving hole connected between the first fitting hole and the second fitting hole, a first locating portion disposed at a rear side of the first fitting hole remote from the receiving hole, and a second locating portion disposed in the second fitting hole. The shock-absorbing socket is mounted on the impact unit of the pneumatic tool, comprising a socket body axially movably mounted in the receiving hole inside the housing, a first coupling portion spaced from a rear side of the socket body and connected to the first locating portion of the housing, a second coupling portion spaced from a front side of the socket body and connected to the second locating portion of the housing, a first spring coil connected between the first coupling portion and the socket body, and a second spring coil connected between the second coupling portion and the socket body.

During reciprocating motion of the impact unit of the pneumatic tool, the first spring coil and the second spring coil are alternatively compressed and stretched to absorb shocks.

Preferably, at least one seal ring is mounted on the periphery of the socket body of the shock-absorbing socket and disposed in close contact with the inside wall of the housing within the receiving hole to prevent air leakage.

The first coupling portion of the shock-absorbing socket is preferably fastened to the first locating portion of the housing by a thread joint. The second coupling portion of the shock-absorbing socket is preferably fastened to the second locating portion of the housing by a thread joint.

### BRIEF DESCRIPITION OF THE DRAWINGS

FIG. 1 is a sectional installed view of a shock-absorbing structure according to the first embodiment of the present invention;

FIG. 2 is a side view in section of the housing for the shock-absorbing structure according to the first embodiment of the present invention;

FIG. 3 is a side view in section of the shock-absorbing socket for the shock-absorbing structure according to the first embodiment of the first embodiment of the present invention;

FIG. 4 is a side view in section of the front cap for the shock-absorbing structure according to the first embodiment of the present invention;

FIG. 5 is a sectional installed view of a shock-absorbing structure according to the second embodiment of the present invention;

FIG. 6 is an exploded view of FIG. 5;

FIG. 7 is a side view in sectional of another alternate form of the shock-absorbing socket for the shock-absorbing structure according to the present invention;

FIG. 8 is a side view in section of still another alternate form of the shock-absorbing socket for the shock-absorbing structure according to the present invention.

### DETAILED DESCRIPTION OF THE PREFERRED EMBODIMENTS

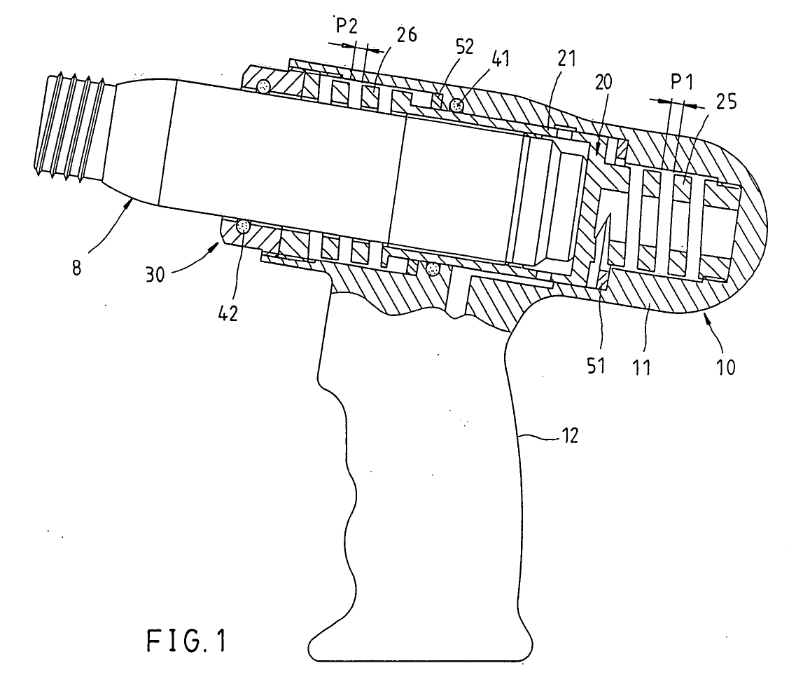

Referring to FIG. 1, a shock-absorbing structure in accordance with the first embodiment of the present invention is installed in a pneumatic tool and adapted to absorb impact shocks from the impact unit 8 of the pneumatic tool.

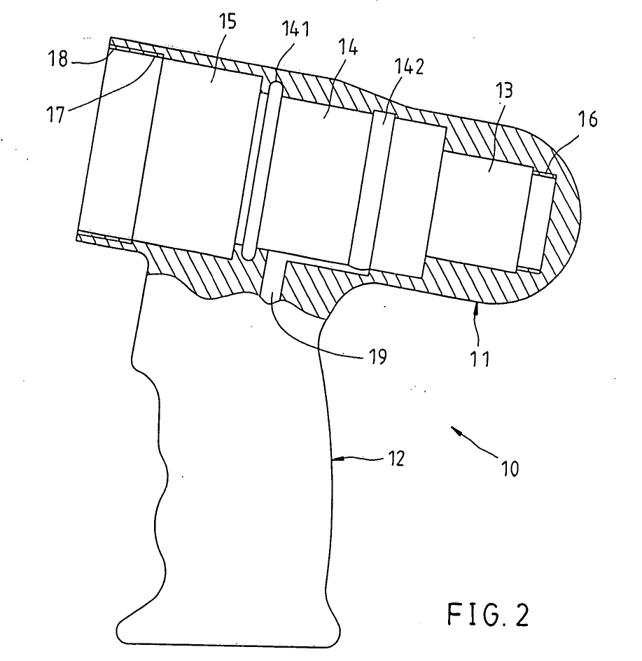

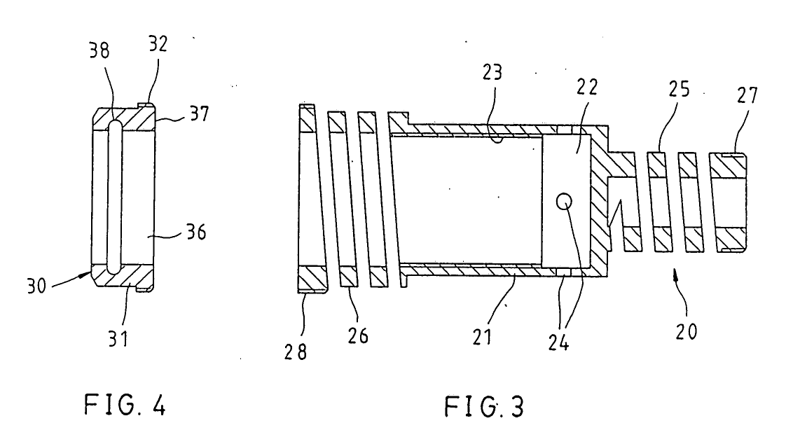

Referring to FIGS. 2-4 and FIG. 1 again, the shock-absorbing structure comprises a housing 10, a shock-absorbing socket 20, a front cap 30, a first ring cushion 51, and a second ring cushion 52.

The housing 10 comprises a mounting body 11, a grip 12 extended from the mounting body 11, a first fitting hole 13 and a second fitting hole 15 formed in the mounting body 11, a receiving hole 14 connected between the first fitting hole 13 and the second fitting hole 15, a groove 141 and an air groove 142 respectively extended around the receiving hole 14, a first locating portion 16 (according to this embodiment, the first locating portion 16 is a thread hole) disposed at the rear side of the first fitting hole 13 remote from the receiving hole 14, a second locating portion 17 and a mounting portion 18 (according to this embodiment, the second locating portion 17 and the mounting portion 18 are thread holes) respectively disposed at the front open side of the second fitting hole 15 remote from the receiving hole 14, and an air passage 19 extended from the air groove 142 to the bottom side of the grip 12. Further, a seal ring 41 is mounted in the locating groove 141.

The shock-absorbing socket 20 comprises a socket body 21 axially movably inserted into the receiving hole 14 of the housing 10 and peripherally closely disposed in contact with the inner diameter of the seal ring 41, an air chamber 22 defined inside the socket body 21, a thread hole 23 formed in the periphery of the socket body 21 in air communication with the air chamber 22 for enabling the socket body 21 to be affixed to the impact unit 8 of the pneumatic tool, a plurality of air holes 24 formed in the socket body 21 in communication between the air chamber 22 and the air groove 142 of housing 10, an externally threaded first coupling portion 27 spaced from one side, namely, the rear side of the socket body 21 for threading into the first locating portion 16 of the housing 10, an externally threaded second coupling portion 28 spaced from the other side, namely, the front side of the socket body 21, a first spring coil 25 connected between the first externally threaded first coupling portion 27 and the socket body 21, and a second spring coil 26 connected between the externally threaded second coupling portion 28 and the socket body 21.

The front cap 30 comprises a cap body 31, a mounting portion 32 extended around the periphery of the cap body 31 and threaded into the mounting portion 18 of the housing 10, a through hole 36 axially extended through the cap body 31 for the passing of the impact unit 8, a stop portion 37 disposed at one side of the cap body 31 and stopped at the externally threaded second coupling portion 28 against the second spring coil 26 of the shock-absorbing socket 20, and an inside annular groove 38 disposed inside the cap body 31 around the through hole 36. Further, a seal ring 42 is mounted in the inside annular groove 38 of the front cap 30.

The first ring cushion 51 is mounted on the periphery of the socket body 21 within the receiving hole 14 of the housing 10 at the connection area between the first spring coil 25 and the socket body 21. The second ring cushion 52 is mounted on the periphery of the socket body 21 within the second fitting hole 15 of the housing 10 at the connection area between the second spring coil 26 and the socket body 21.

The assembly process and operation of the shock-absorbing structure are outlined hereinafter.

At first, the first externally threaded first coupling portion 27 and the first spring coil 25 are inserted with the shock-absorbing socket 20 into the first fitting hole 13 of the housing 10 to thread the externally threaded first coupling portion 27 and the externally threaded second coupling portion 28 into the first locating portion 16 and the second locating portion 17 respectively. When assembled, the seal ring 41 is sealed to the periphery of the receiving hole 14 inside the housing 10, the air groove 142 of the housing 10 is in air communication with the air holes 24 of the shock-absorbing socket 20, and the second spring coil 26 is suspended in the second fitting hole 5 of the housing 10. At this time, a gap P1 is formed in between each two adjacent turns of the first spring coil 25, and a gap P2 is formed in between each two adjacent turns of the second spring coil 27.

During operation of the pneumatic tool, the impact unit 8 is forced by air force from the air compressor (not shown) to carry the shock-absorbing socket 20 forwards (because of small position change, no further drawing to show the position change is necessary), thereby causing the first spring coil 25 to be stretched and the second spring coil 26 to be compressed, i.e., the gap P1 is increased and the gap P2 is reduced. Because of the two-way shock-absorbing effect of the shock-absorbing socket 20, the shock-absorbing structure greatly lessens shocks from the housing 10 during forward stroke of the impact unit 8.

When in the reversed direction, i.e., when the impact unit 8 pressed against the workpiece or moved backwards, a high pressure is given to the shock-absorbing socket 20. At this time, the first spring coil 25 is compressed to reduce the gap P1 and the second spring coil 26 is stretched to increase the gap P2, lessening shocks from the housing 10.

Therefore, the first spring coil 25 and the second spring coil 26 are respectively and alternatively compressed and stretched to lessen shocks during reciprocating motion of the impact unit 8.

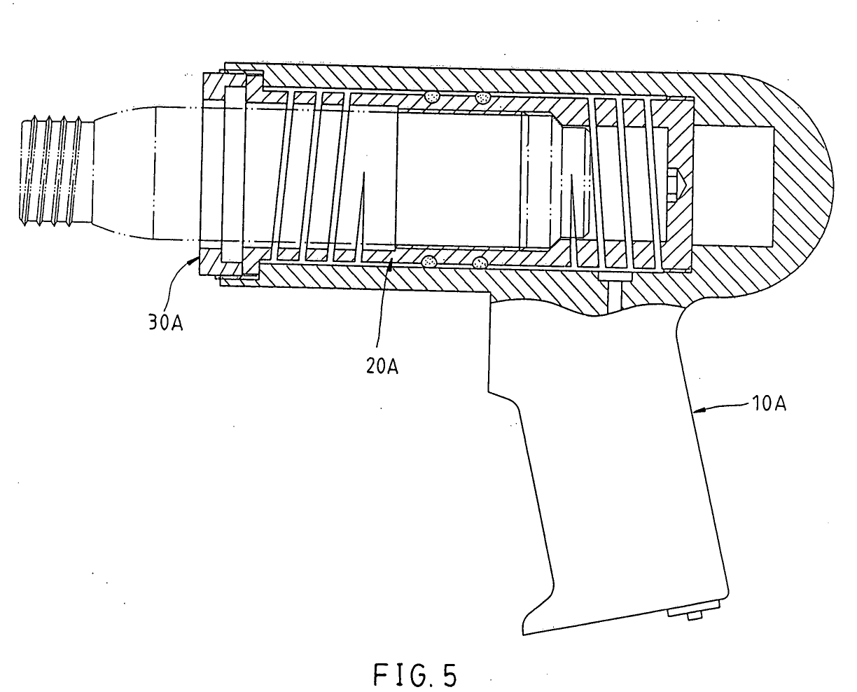

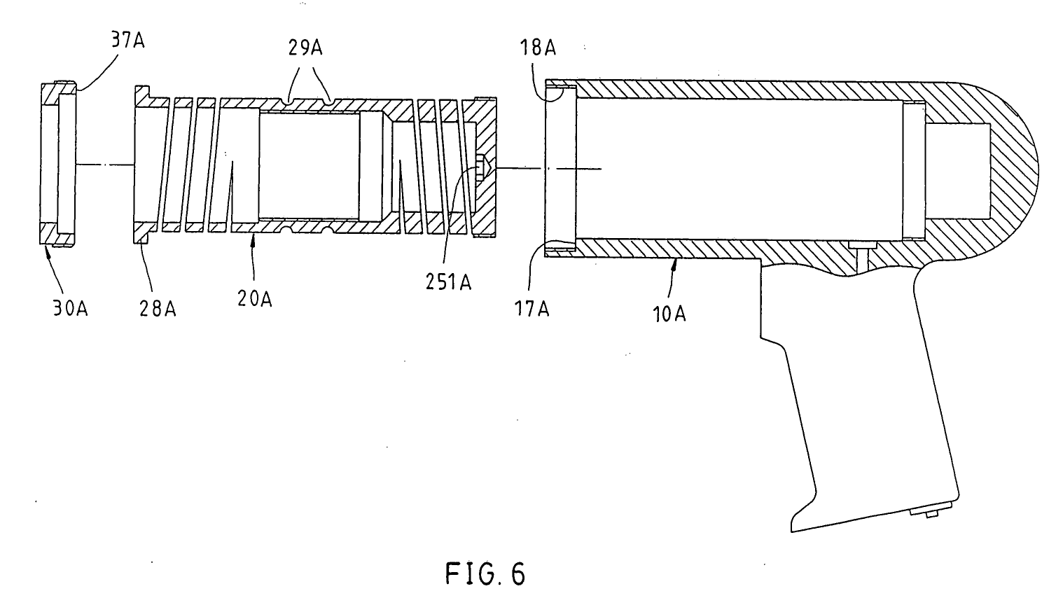

FIG. 5 and show a shock-absorbing structure according to the second embodiment of the present invention. Similar to the aforesaid first embodiment, this second embodiment is also comprised of a housing 10A, a shock-absorbing socket 20A, and a front cap 30A.

According to this embodiment, the first and second fitting holes and receiving hole of the housing 10A are substantially equal in diameter. The housing 10A further has an annular stop edge 17A disposed inside the mounting portion 18A.

The socket body, first spring coil and second spring coil of the shock-absorbing socket 20A have the same outer diameter. The socket body of the shock-absorbing socket 20A has two outside annular grooves 29A for the mounting of a respective seal ring. The second coupling portion 28A of the shock-absorbing socket 20A is a flange (without outer thread), which is stopped at the stop edge 17A of the housing 10A. Further, the shock-absorbing socket 20A has a hexagonal hole 251A disposed at one end inside the first spring coil for the positioning of a wrench to thread the shock-absorbing socket 20A into the housing 10A.

The front cap 30A is threaded into the mounting portion 18A of the housing 10A, having a stop portion 37A adapted to stop the second coupling portion 28A of the shock-absorbing socket 20A against the annular stop edge 17A of the housing 10A. This second embodiment works similar to the aforesaid first embodiment, and achieves same effect.

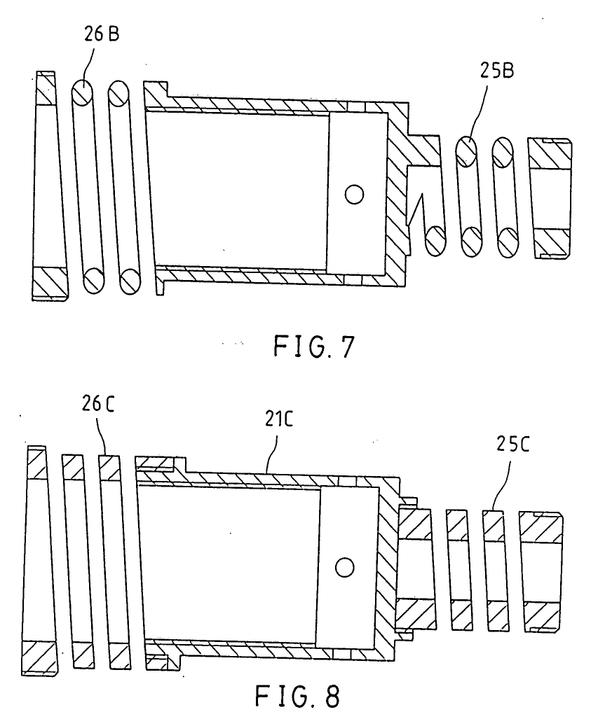

FIG. 7 is a sectional view of the shock-absorbing socket according to another alternate form of the present invention. According to this alternate form, the first spring coil 25B and the second spring coil 26B have a circular cross section. The first spring coil 25B and the second spring coil 26B are formed integral with the socket body, namely, the shock-absorbing socket 20 is a unitary structure. When one of said first or second spring coils 25B and 26B is compressed, the other of these two spring coils will be tensioned (please note that it is tensioned not released), so that the two spring coils can work well with each to make shock-absorbing socket 20 return to its original position once a shock-absorbing action is finished, and thus the shock-absorbing effect is improved.

Alternatively, the first spring coil 25B and the second spring coil 26B can be made by die cast or sand cast.

FIG. 8 is a sectional view of the shock-absorbing socket according to still another alternate form of the present invention. According to this alternate form, the socket body 21C, the first spring coil 25C, the second spring coil 26C are independent members respectively fastened together by any of a variety of fastening measures, for example, thread joint, welding, riveting.

Further, the seal ring between the periphery of the socket body of the shock-absorbing socket and the receiving hole of the housing may be eliminated, for enabling compressed air to be directly guided to the impact unit. The grip may be made detachable so that the user can attach any of a variety of grips to the mounting portion of the housing. This detachable grip design enables the housing to be processed by a lathe or machine tool.

As indicated above, the invention has the following features:

1. The two-way shock-absorbing design of the shock-absorbing socket doubles the shock-absorbing effect of the shock-absorbing structure.

2. The simple design of the shock-absorbing socket and the housing enables the user to detachably assemble the shock-absorbing structure with less effort.

3. Due to the perfect design and way of work of the shock-absorbing socket, the shock-absorbing structure is durable in use.

4. The first spring coils and the second spring coils are formed integral with the socket body, namely, the shock-absorbing socket 20 is a unitary structure. When one of said first or second spring coils 25B and 26B is compressed, the other of these two spring coils will be tensioned

What is claimed is:

1. A shock-absorbing structure installed in an pneumatic tool and adapted to absorb shocks from an impact unit of the pneumatic tool, the shock-absorbing structure comprising:
a housing, said housing comprising a mounting body, a first fitting hole and a second hole formed in said mounting body, a receiving hole connected between said first fitting hole and said second fitting hole, said receiving being larger than said first fitting hole but smaller than said second fitting hole in diameter, a first locating portion disposed at a rear side of said first fitting hole remote from said receiving hole, and a second locating portion disposed in said second fitting hole; and
a shock-absorbing socket mounted on the impact unit of said pneumatic tool, said shock-absorbing socket comprising a socket body axially movably mounted in said receiving hole inside said housing, a first coupling spaced from a rear side of said socket body and connected to the first locating portion of said housing, a second coupling portion spaced from a front side of said socket body and connected to the second locating portion of said housing, a first spring coil connected between said first coupling portion and said socket body and confined in said first fitting hole of said mounting body, and a second spring coil connected between said second coupling portion and a said socket body and confined in said second fitting hole of said mounting body;
a front cap comprising a cap body, a mounting portion extended from said cap body and fastened to said housing, and a through hole axially extended through said cap body for the passing of the impact unit for said pneumatic tool;
wherein said first spring coil and said second spring coil of said shock-absorbing socket are respectively formed integral with said socket body, so that when one of said first or second spring coils is compressed, the other of these two spring coils will be tensioned.

2. The shock-absorbing structure as claimed in claim 1, wherein the first coupling portion of said shock-absorbing socket is fastened to the first locating portion of said housing by a thread joint.

3. The shock-absorbing structure as claimed in claim 1, wherein the second coupling portion of said shock-absorbing socket is fastened to the second locating portion of said housing by a thread joint.

4. The shock-absorbing structure as claimed in claim 1, wherein said front cap has a stop portion disposed at one side of said cap body and stopped at the second coupling portion of said shock-absorbing socket against said second spring coil.

5. The shock-absorbing structure as claimed in claim 4, wherein the second coupling portion of said shock-absorbing socket is a flange, said housing has a stop edge adapted to support the flange of said shock-absorbing socket.

6. The shock-absorbing structure as claimed in claim 1, wherein said first spring coil and said second spring coil of said shock-absorbing socket are respectively formed integral with said socket body.
